(19) United States
(12) Patent Application Publication
(10) Pub. No.: US 2026/0260624 A1
(43) Pub. Date: Sep. 3, 2026

(54) DISPLAY DEVICE AND DRIVING METHOD THEREOF

(71) Applicant: LG Display Co., Ltd., Seoul (KR)

(72) Inventors: Sang Hyun PARK, Paju-si (KR); Ki Jin CHOI, Paju-si (KR)

(21) Appl. No.: 19/407,551

(22) Filed: Dec. 3, 2025

(30) Foreign Application Priority Data
Feb. 28, 2025 (KR) 10-2025-0026376

(51) Int. Cl. G09G 3/3275; G09G 3/3233; G09G 3/3266

(52) U.S. Cl. CPC G09G 3/3275; G09G 3/3233; G09G 3/3266; G09G 2300/0842; G09G 2310/08; G09G 2320/0257; G09G 2330/021; G09G 2340/0435; G09G 2370/10

(57) ABSTRACT

A display device and a driving method thereof. The display device includes a data driver including a data channel connected to data lines and the reference voltage lines and configured to output a data voltage in response to a source output enable signal, and a sensing channel configured to sample voltages of the reference voltage lines in response to a switch control signal and output sensing data during a sensing interval; and a timing controller configured to transmit control data indicating a pulse timing and pixel data of an input image to the data driver.

### CROSS REFERENCE TO RELATED APPLICATION

This application claims priority from and the benefit of Korean Patent Application No. 10-2025-0026376, filed on February 28, 2025, which is hereby incorporated by reference for all purposes as if fully set forth herein.

### BACKGROUND

### Field

Embodiments of the invention relate generally to a display device capable of sensing electrical characteristics of pixels and a driving method thereof.

### Discussion of the Background

Various flat panel displays, such as a liquid crystal display and an electroluminescence display, are known. The electroluminescence display may use light-emitting elements provided in each of pixels to emit light by itself without a backlight and may display an input image. The light-emitting elements of the electroluminescence display may be divided into organic light-emitting elements and inorganic light-emitting elements, depending on a material for a light-emitting layer. An active matrix type electroluminescence display has advantages of a high response speed, high light emission efficiency, high luminance, and a wide viewing angle since an organic light emitting diode (hereinafter, referred to as an "OLED") is provided in each pixel, and is excellent in contrast ratio and color reproducibility since a black grayscale can be expressed as complete black.

The organic light emitting display device may include a sensing circuit and a compensation circuit to improve image quality. Each pixel of the organic light emitting display device may include a light-emitting element and a transistor that drives the light-emitting element. It is difficult to manufacture the light-emitting elements and the transistors with the completely same characteristics in all pixels due to dispersion in a manufacturing process of a display panel. The compensation circuit may sense electrical characteristics of pixels and compensate for the deterioration of the electrical characteristics of the pixels on the basis of a sensing result.

The above information disclosed in this Background section is only for understanding of the background of the inventive concepts, and, therefore, it may contain information that does not constitute prior art.

### SUMMARY

Display devices according to embodiments of the invention are capable of accurately sensing electrical characteristics of pixels and a driving method thereof.

Additional features of the inventive concepts will be set forth in the description which follows, and in part will be apparent from the description, or may be learned by practice of the inventive concepts.

According to one or more embodiments of the invention, a display device includes: a display panel in which a plurality of data lines, a plurality of gate lines, a plurality of reference voltage lines, and a plurality of sub-pixels are disposed; a data driver including a data channel connected to the data lines and the reference voltage lines and configured to output a data voltage in response to a source output enable signal, and a sensing channel configured to sample voltages of the reference voltage lines in response to a switch control signal and output sensing data during a sensing interval; a gate driver connected to the gate lines; and a timing controller configured to transmit control data indicating a pulse timing and pixel data of an input image to the data driver. The data channel of the data driver includes an output switch element that blocks an electrical path between the data channel and the data line in response to a pulse of the source output enable signal. The pulse of the source output enable signal and a pulse of the switch control signal do not temporally overlap each other during the sensing interval.

The display device may further include: a memory in which a plurality of pieces of timing setting data with different pulse start timings and pulse widths is stored. The control data may include pulse start timing and pulse width information. The timing controller may adjust a pulse timing of one of the source output enable signal and the switch control signal on the basis of the pulse start timing and the pulse width read from the memory.

The timing controller may transmit control data packet including data indicating a pulse start timing and a pulse width to the data driver. The data driver may generate the pulse of the source output enable signal or the pulse of the switch control signal on the basis of the pulse start timing and the pulse width restored from the control data packet.

Each of the sub-pixels may be connected to corresponding data line, gate line, and reference voltage line. The sensing channel of the data driver may include: an analog-to-digital converter configured to convert a voltage charged in the reference voltage line into a digital signal and output the sensing data; and a sampling switch configured to connect the reference voltage line to an input terminal of the analog-to-digital convert in response to the pulse of the switch control signal during a sampling interval of the sensing interval. The sensing data may be transmitted to the timing controller.

The data channel of the data driver may further include: a digital-to-analog converter configured to convert the pixel data into a data voltage; and an output buffer configured to output the data voltage input from the digital-to-analog converter. The output switch element may be connected to an output terminal of the output buffer and electrically separate the output terminal of the output buffer from the corresponding data line in response to the pulse of the source output enable signal and electrically connect the output terminal of the output buffer to the corresponding data line during an interval of a low voltage of the source output enable signal.

The timing controller may calculate an average value of sensing data received from the data driver during the sensing interval, and compare the average value of the sensing data with a preset threshold value. When the average value is greater than the threshold value, the timing controller may delay a pulse start timing and a pulse width of the source output enable signal or the switch control signal to control the pulse of the source output enable signal and the pulse of the switch control signal in a non-overlapping state.

The display device may further include a plurality of drive ICs including the data driver. A data channel of each of the drive ICs may be electrically connected to the corresponding data line during an interval of a low voltage of the source output enable signal and may be electrically separated from the corresponding data line in response to the pulse of the source output enable signal. A sensing channel of each of the drive ICs may be electrically connected to the reference voltage line using a switch that responds to the pulse of the switch control signal and electrically separated from the reference voltage line during an interval of a low voltage of the switch control signal.

The timing controller may calculate an average value of sensing data received from each of the drive ICs during the sensing interval by drive IC. The timing controller may compare a difference between the average values calculated for adjacent drive ICs with a preset threshold value. When the difference between the average values obtained from the adjacent drive ICs is greater than the threshold value, the timing controller may determine one of the adjacent drive ICs as a drive IC that outputs abnormal sensing data. The timing controller may delay the pulse of the source output enable signal or the pulse of the switch control signal that controls the drive IC outputting the abnormal sensing data, to control the pulse of the source output enable signal and the pulse of the switch control signal that controls the drive IC outputting the abnormal sensing data in a non-overlapping state.

According to yet another embodiment of the invention, a method for driving a display device includes: transmitting control data indicating a pulse timing to the data driver; by the data driver, generating a pulse of the source output enable signal and a pulse of the switch control signal on the basis of the control data; and causing the pulse of the source output enable signal and the pulse of the switch control signal not to overlap each other during the sensing interval. The data channel of the data driver includes an output switch element that blocks an electrical path between the data channel and the data line in response to a pulse of the source output enable signal.

The method for driving a display device may further include: by a timing controller, transmitting a control data packet including data indicating a pulse start timing and a pulse width to the data driver; and, by the data driver, generating the pulse of the source output enable signal or the pulse of the switch control signal on the basis of the pulse start timing and the pulse width restored from the control data packet.

The method for driving a display device may further include: by the timing controller, calculating an average value of sensing data received from the data driver during the sensing interval; by the timing controller, comparing the average value of the sensing data with a preset first threshold value; and, by the timing controller, when the average value is greater than the first threshold value, changing a pulse start timing and/or a pulse width of the source output enable signal or the switch control signal to control the pulse of the source output enable signal and the pulse of the switch control signal in a non-overlapping state

The method for driving a display device may further include: causing a data channel of each of a plurality of drive ICs with the data driver integrated to be electrically connected to a corresponding data line during an interval of a low voltage of the source output enable signal and electrically separated from the corresponding data line in response to the pulse of the source output enable signal; and causing a sensing channel of each of the drive ICs to be electrically connected to the reference voltage line using a switch that responds to the pulse of the switch control signal and electrically separated from the reference voltage line during an interval of a low voltage of the switch control signal.

The method for driving a display device may further include: by the timing controller, calculating an average value of sensing data received from each of the drive ICs during the sensing interval by drive IC; by the timing controller, comparing a difference between the average values calculated for adjacent drive ICs with a preset second threshold value; by the timing controller, when the difference between the average values obtained from the adjacent drive ICs is greater than the second threshold value, determining one of the adjacent drive ICs as a drive IC that outputs abnormal sensing data; and, by the timing controller, delaying the pulse of the source output enable signal or the pulse of the switch control signal that controls the drive IC outputting the abnormal sensing data, to control the pulse of the source output enable signal and the pulse of the switch control signal that control the drive IC outputting the abnormal sensing data in a non-overlapping state.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram illustrating a display device according to an embodiment of the invention.

FIG. 2 is a diagram illustrating an example of a sensing interval.

FIG. 3 is a diagram illustrating one frame interval of the display device.

FIG. 4 is a circuit diagram illustrating a data driver electrically connected to a pixel circuit according to an embodiment of the invention.

FIG. 5 is a waveform chart illustrating an operation to sense electrical characteristics of pixels during a sensing interval in steps.

FIG. 6 is a diagram illustrating a connection structure of a display panel and a circuit board according to an embodiment of the invention.

FIG. 7 is a block diagram illustrating a data channel configuration of a drive IC according to an embodiment of the invention;

FIG. 8 is a waveform chart illustrating an example of an output signal and a data voltage illustrated in FIG. 7.

FIG. 9 is a waveform chart illustrating an example where a pulse of a source output enable signal and a pulse of a switch control signal temporally overlap each other.

FIG. 10 is a waveform chart illustrating an example where the pulse of the source output enable signal and the pulse of the switch control signal do not temporally overlap each other.

FIG. 11 is a flowchart illustrating a driving method of the display device according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z – axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The advantages and features of the invention and methods for accomplishing the same will be more clearly understood from embodiments described below with reference to the accompanying drawings. However, the invention is not limited to the following embodiments but may be implemented in various different forms. Rather, the present embodiments will make the disclosure of the invention complete and allow those skilled in the art to completely comprehend the scope of the invention.

The following embodiments can be partially or entirely bonded to or combined with each other and can be linked and operated in technically various ways. The embodiments can be carried out independently of or in association with each other.

The pixel circuit and the gate drive circuit of the display device may include a plurality of transistors. The transistor may be implemented as a thin film transistor (TFT). The transistors may be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, this description does not limit a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage, and the gate-off voltage may be a gate low voltage VGL. In the case of a p-channel transistor, the gate-on voltage may be the gate low voltage VGL, and the gate-off voltage may be the gate high voltage.

Hereinafter, various embodiments of the invention will be described in detail with reference to the accompanying drawings.

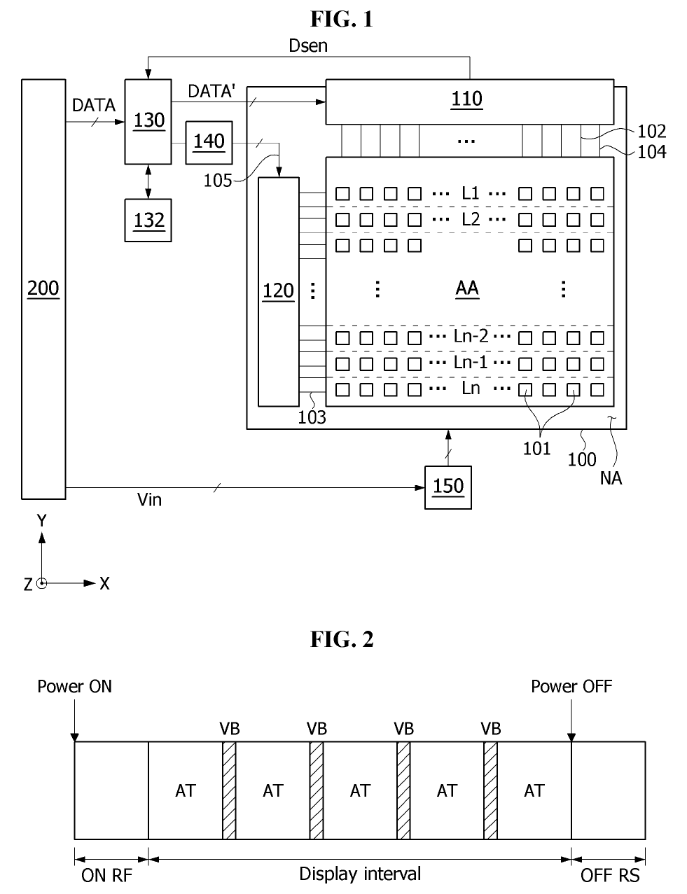

Referring to FIG. 1, a display device according to an embodiment of the invention includes a display panel 100, a display panel driving circuit including data driver 110 and gate driver 120 for writing pixel data to pixels 101 of the display panel 100, a power supply 150 that generates power necessary for driving the pixels 101, the data driver 110, the gate driver 120, and the like.

The display panel 100 may be a rectangular panel having a width in the X-axis direction, a length in the Y-axis direction, and a thickness in the Z-axis direction, but embodiments of the invention are not limited thereto. A screen of the display panel 100 may include a display area AA and a non-display area outside the display area AA. The display area AA of the display panel 100 includes a pixel array that displays an input image. The pixel array includes a plurality of data lines 102, a plurality of gate lines 103 that intersect the data lines 102, a plurality of reference voltage lines 104, and pixels 101 that are disposed in a matrix. The display panel 100 may further include power lines connected in common to the pixels 101. The power lines may be connected in common to pixel circuits and may supply voltages necessary for driving the pixels 101, to the pixels 101.

The data lines 102 are disposed in the form of long wires along the Y-axis direction of the display panel 100 and are electrically connected to data channels of the data driver 110. The reference voltage lines 104 may be disposed on the display panel parallel to the data lines 102, and may be connected to the pixels 101 and sensing channels of the data driver 110. The gate lines 103 may be disposed in the form of long wires along the X-axis direction of the display panel 100, intersect the data lines 102, and are electrically connected to output terminals of the gate driver 120.

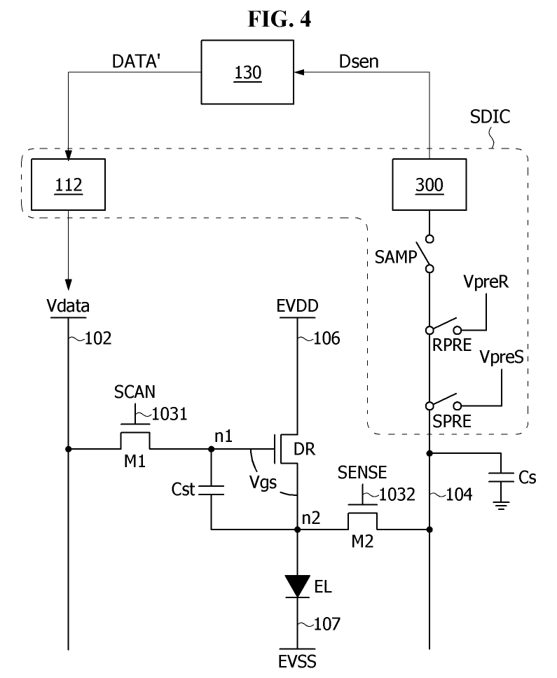

Each of the pixels 101 may be divided into a red sub-pixel, a green sub-pixel, and a blue sub-pixel for color implementation. Each pixel 101 may further include a white sub-pixel. Each sub-pixel includes a pixel circuit for driving a light-emitting element. Each pixel circuit is connected to the data line 102, the gate lines 103, and the power lines. The pixel circuit may be implemented as a circuit illustrated in FIG. 4, but embodiments of the invention are not limited thereto.

The pixel array includes a plurality of pixel lines L1 to Ln. Each of the pixel lines L1 to Ln includes the pixels of one line disposed along the X-axis direction in the pixel array of the display panel 100. The pixels disposed in one pixel line share the gate lines 103. The sub-pixels disposed in the Y-axis direction along the data line 102 share the same data line 102. One horizontal interval 1 H is a time obtained by dividing one frame interval by the total number of pixel lines L1 to Ln.

The display panel 100 may be implemented as a non-transmissive display panel or a transmissive display panel. The transmissive display panel may be applied to a transparent display device in which an image is displayed on a screen and a real object in a background is visible. The display panel 100 may be manufactured as a flexible display panel.

The power supply 150 adjusts a level of a direct-current input voltage Vin applied from a host system 200 and outputs a first voltage V1 necessary for driving the pixel array of the display panel 100, the data driver 110, and the gate driver. The power supply 150 may include a DC-DC converter. The DC-DC converter may include a charge pump, a regulator, a buck converter, a boost converter, and the like. The power supply 150 may output a gamma reference voltage, a gate high voltage, a gate low voltage, a pixel driving voltage, a pixel ground voltage, a reference voltage, an integrated circuit (IC) driving voltage, and the like through the DC-DC converter. The voltages that are output from the power supply 150 may be constant voltages (or direct-current voltages). The gamma reference voltage is supplied to the data driver 110. A dynamic range of a data voltage that is output from the data driver 110 is determined according to a voltage range of the gamma reference voltage. The dynamic range of the data voltage has a voltage range between a highest grayscale voltage and a lowest grayscale voltage. A voltage level of the data voltage is selected on the basis of a grayscale value of pixel data.

The gate high voltage and the gate low voltage are supplied to a level shifter 140 and the gate driver 120. The voltages such as the pixel driving voltage, the pixel ground voltage, and the reference voltage are supplied to the pixels 101 via the power lines connected in common to the pixels 101. The IC driving voltage is a driving voltage of a driver (source driver) embedded with circuits of a timing controller 130 and the data driver 110.

The power supply 150 may be implemented as a power IC such as a power management integrated circuit (PMIC) or an electronics integrated circuit (ELIC), but embodiments of the invention are not limited thereto. The power supply 150 may adjust an output voltage under the control of the timing controller 130. For example, when the power supply 150 is connected to the timing controller 130 via a serial interface such as I2C, the timing controller 130 may transmit an instruction signal including a register setting value in a voltage control register of the power supply 150 to the power supply 150 and vary a voltage level of a voltage that is output from the power supply 150.

The display panel driving circuit including data driver 110 and gate driver 120 writes pixel data of an input image to the pixels of the display panel 100 under the control of the timing controller 130. The data driver 110 and gate driver 120 may further include de-multiplexers (DEMUX) disposed between the data driver 110 and the data lines 102, but embodiments of the invention are not limited thereto. When the de-multiplexers are disposed between output terminals of the data driver 110 and the data lines 102, the number of data channels of the data driver 110 may be reduced.

The display device may include a sensing circuit connected to the sub-pixels. The sensing circuit converts a sensing voltage obtained from the sub-pixels via the reference voltage line 104 into a digital signal (hereinafter, referred to as "sensing data") Dsen and transmits the converted digital signal to the timing controller 130. The sensing circuit may be disposed in a sensing channel of the data driver 110.

Touch sensors to sense a touch input may be disposed on the display panel 100. The touch sensors may be disposed on the display panel 100 as an on-cell type or an add-on type, or may be implemented as in-cell type touch sensors embedded in the pixel array.

The display panel driving circuit including data driver 110 and gate driver 120 may further include a touch sensor driver to drive the touch sensors. The touch sensor driver is not illustrated in FIG. 1. The data driver 110 and the touch sensor driver may be integrated in one drive IC.

The data driver 110 includes data channels that are electrically connected to the data lines 102 and output data voltages, and sensing channels that are electrically connected to the reference voltage lines 104 and receive sensing voltages. The data channels receive pixel data of the input image received as the digital signal from the timing controller 130 as input and output the data voltages during a display interval. The sensing channels sense the electrical characteristics of the pixels via the reference voltage lines 104 during a sensing interval. The electrical characteristics of the pixel may be the electrical characteristics of the light-emitting element and/or the driving transistor in each sub-pixel, for example, mobility and a threshold voltage.

The data channels of the data driver 110 convert pixel data DATA' of the input image received from the timing controller 130 into a gamma compensation voltage using a digital-to-analog converter (hereinafter, referred to as "DAC") and output data voltages of pixel data. The gamma reference voltage is divided into grayscale-specific gamma compensation voltages through a voltage division circuit. The grayscale-specific gamma compensation voltages are provided to the DAC of the data driver 110. The data voltages are output from the respective channels of the data driver 110 via output buffers.

The sensing channels of the data driver 110 include an analog-to-digital converter (hereinafter, referred to as "ADC"). The sensing channels convert sensing voltages received via the reference voltage lines 104 into digital data using the ADC and output sensing data Dsen during the sensing interval. The sensing data Dsen is transmitted to the timing controller 130.

The gate driver 120 may be provided in at least one non-display area NA on the right and left sides outside the display area AA in the display panel 100, or at least a part of the gate driver 120 may be provided in the display area AA.

The gate driver 120 may be disposed in the non-display areas NA on both sides of the display panel 100 with the display area AA of the display panel interposed therebetween and may supply gate pulses on both sides of the gate lines 103 by a double feeding method. In another embodiment, the gate driver 120 may be disposed in at least one of the right and left non-display areas AA of the display panel 100 and may supply gate pulses to the gate lines 103 by a single feeding method. The gate driver 120 sequentially outputs the pulses of the gate signals to the gate lines 103 under the control of the timing controller 130. The gate driver 120 may supply the signals to the gate lines 103 by shifting the pulse of the gate signal using a shift register. A plurality of gate signals may be applied to the pixel circuit. In this case, the gate driver 120 may include a plurality of shift registers that output the pulses of the gate signals.

The timing controller 130 receives digital video data of the input image and timing signals synchronized with the data from the host system 200. The timing signals may include a vertical synchronization signal Vsync, a horizontal synchronization signal Hsync, a data enable signal DE, and the like. Because a vertical interval and a horizontal interval can be known by a method of counting the data enable signal DE, the vertical synchronization signal Vsync and the horizontal synchronization signal Hsync may be omitted. The horizontal synchronization signal Hsync and the data enable signal DE have a cycle of one horizontal interval 1 H.

The timing controller 130 generates a data timing control signal to control an operation timing of the data driver 110 and a gate timing control signal to control an operation timing of the gate driver 120 on the basis of the timing signals Vsync, Hsync, and DE received from the host system 200. The timing controller 130 controls an operation timing of the display panel driving circuit to synchronize the data driver 110 and the gate driver 120.

The gate timing control signal output from the timing controller 130 may be input to the shift register of the gate driver 120 via the level shifter 140. The level shifter 140 may convert the gate timing control signal received from the timing controller 130 via clock lines 105 to have a swing width between the gate high voltage and the gate low voltage and supply the converted gate timing control signal to the gate driver 120. The gate timing control signal output from the level shifter 140 may include a start signal, a clock, a line selection signal, a reset signal, and the like, but embodiments of the invention are not limited thereto. The gate driver 120 outputs the pulses of the gate signals to write pixel data to the sub-pixels during the display interval in response to the gate timing control signal input from the level shifter 140, and outputs the pulses of the gate signals to sense the electrical characteristics of the sub-pixels during the sensing interval.

The data driver 110 and gate driver 120 may be driven at a variable refresh rate (VRR) under the control of the timing controller 130. For example, the timing controller 130 decreases a refresh rate of an image displayed on the display panel 100 according to a frequency of the input image or on the basis of a result of analyzing the input image, thereby reducing the power consumption of the display device and improving image quality. With the variable refresh rate, the refresh rate of the image displayed on the display panel 100 may be varied to 60 Hz, 120 Hz, 144 Hz, 165 Hz, 240 Hz, and the like, but embodiments of the invention are not limited thereto. For example, the refresh rate may be decreased to 1 Hz.

The data driver 110 and gate driver 120 may reduce the power consumption of the display device by decreasing the refresh rate of the pixels 101 when a still image is input for a given time or more under the control of the timing controller 130. The refresh rate may be decreased when the display device operates in a standby mode or in response to a user's command. The refresh rate may be decreased on an always-on display (AOD) screen. The AOD screen may be a partial pixel area of the display area AA where preset information, for example, brief information such as a remaining battery quantity and time is displayed in the standby mode.

The host system 200 may convert the resolution of an image signal from a video source to match the resolution of the display panel 100 and transmit the converted image signal to the timing controller 130 along with the timing signals.

The sub-pixels in the display area AA are sequentially sensed during the preset sensing interval under the control of the timing controller 130, thereby sensing the electrical characteristics of the light-emitting element and/or the driving transistor in all sub-pixels, for example, the mobility and the threshold voltage.

The timing controller 130 may determine the electrical characteristics of circuit elements in the sub-pixel, for example, the light-emitting element and the driving transistor on the basis of the sensing data Dsen received from the sensing circuit of the data driver 110. The timing controller 130 derives a compensation value to compensate for the electrical characteristics of each sub-pixel on the basis of the sensing data Dsen. For example, the timing controller 130 may derive a compensation value to compensate for the optical and electrical characteristics of the pixels on the basis of the sensing data Dsen by executing a preset compensation algorithm or may input the sensing data Dsen to a look-up table (LUT) stored in a memory 132 and derive a compensation value output from the look-up table.

In the look-up table, compensation values corresponding to initial optical and electrical characteristic values measured by sub-pixel in an aging process and an inspection process of the display panel are set by sub-pixel. The compensation values stored in the look-up table may be updated according to a sensing value in which deterioration accumulated as the sub-pixels are driven for a longer time is reflected. A compensation circuit of the timing controller 130 may add or multiply the compensation value derived from the look-up table to the pixel data of the input image, thereby compensating for electrical characteristic deviation and change of the light-emitting element and/or the driving transistor in each sub-pixel.

The memory 132 may store driving setting timing information of the data driver 110 and gate driver 120, the look-up table from which the compensation values are derived on the basis of the sensing results of the sub-pixels, a program code of a compensation algorithm to improve image quality, and the like. The memory 132 may include a non-volatile memory and a volatile memory. The non-volatile memory may include one or more of readable and writable memories, for example, a NAND flash memory, a NOR flash memory, and an electrically erasable programmable read-only memory (EEPROM). The NAND flash memory may be a single level cell (SLC) type. The volatile memory may include one or more of a dynamic RAM (DRAM), a static RAM (SRAM), a synchronous dynamic RAM (SDRAM), and a double data rate SDRAM (DDR SDRAM).

As illustrated in FIG. 2, the sensing circuit may be driven during a sensing interval set in at least one of a power-on sequence in which power starts to be applied to the display device and a power-off sequence, and may sense the electrical characteristics of the sub-pixels. The sensing circuit may sense the electrical characteristics of the sub-pixel during a vertical blank interval (VB) in which pixel data is not present, of the display interval. During the sensing interval, the sensing data Dsen output from the sensing channels of the data driver 110 is transmitted to the timing controller 130.

In FIG. 2, "ON RF" represents the sensing interval of the sub-pixels in the power-on sequence. "OFF RS" represents the sensing interval of the sub-pixels in the power-off sequence. During the sensing interval ON RF in the power-on sequence, the mobility of the driving transistor in each sub-pixel may be sensed. During the sensing interval OFF RS in the power-off sequence, the mobility of the driving transistor in each sub-pixel may be sensed.

The power-off sequence OFF RS is a process in which power is turned off in a predetermined order when a user's command to turn on a power-off switch of the display device is received from the user. The timing controller 130, the sensing circuit of the data driver 110, and the gate driver 120 may be further driven for a predetermined time after the power-off switch is turned on in the power-off sequence OFF RS, and may be stopped when the output of the power supply is blocked after the electrical characteristics of the driving transistor and/or the light-emitting element in each sub-pixel are sensed.

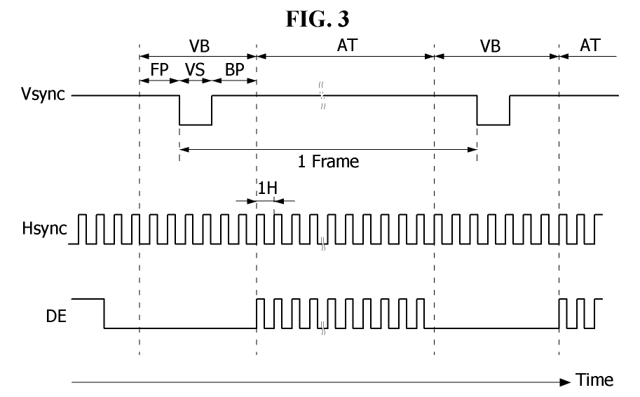

FIG. 3 is a diagram illustrating one frame interval of the display device. In FIG. 3, the vertical synchronization signal Vsync, the horizontal synchronization signal Hsync, and the data enable signal DE are the timing signals synchronized with the pixel data of the input image.

Referring to FIG. 3, one frame interval (1 Frame) is divided into an active interval AT and the vertical blank interval VB in which pixel data is not present. The vertical blank interval VB includes a vertical sync interval VS, a vertical front porch interval FP, and a vertical back porch interval BP.

The pixel data of the input image may be input to the timing controller 130 during the active interval AT, and the data driver 110 may output the data voltage. The vertical blank interval VB is an interval in which pixel data is not present, between an active interval AT of an (N-1)t-h (where N is a natural number) frame interval and an active interval AT of an N-th frame interval. The data driver 110 outputs the data voltage of the pixel data during the active interval AT, but does not output the data voltage during the vertical blank interval VB. When the refresh rate is decreased, the vertical blank interval VB may be expanded and further extended.

The vertical synchronization signal Vsync defines one frame interval. One pulse cycle of the horizontal synchronization signal Hsync and the data enable signal DE is one horizontal interval 1 H. The data enable signal DE defines a valid data interval in which the pixel data of the input image is present.

FIG. 4 is a circuit diagram illustrating the data driver electrically connected to the pixel circuit according to the embodiment of the invention. The sensing circuit of the data driver and the pixel circuit are not limited to those in FIG. 4. In FIG. 4, "SDIC" represents a drive IC in which the circuit of the data driver 110 is integrated. FIG. 5 is a waveform chart illustrating an operation to sense electrical characteristics of pixels during a sensing interval in steps. The sensing interval illustrated in FIG. 5 may be the sensing interval set in the power-off sequence.

Referring to FIG. 4, the pixel circuit may include a light-emitting element EL, a driving transistor DR, a capacitor Cst, a first switch transistor M1, and a second switch transistor M2.

The pixel circuit is connected to a data line 102, gate lines 1031 and 1032, a reference voltage line 104, a first constant voltage node 106 to which a pixel driving voltage EVDD is applied, and a second constant voltage node 107 to which a pixel ground voltage EVSS is applied. The constant voltage nodes 106 and 107 are connected to the power lines connected in common to the pixels. The pixel driving voltage EVDD is set to a voltage at which the driving transistor DR operates in a saturation region. The pixel driving voltage EVDD is a voltage higher than a maximum voltage (or a white grayscale voltage) of a data voltage Vdata. The pixel ground voltage EVSS is a voltage lower than a minimum voltage (or a black grayscale voltage) of the data voltage Vdata.

Reference voltages VpreR and VpreS may include a reference voltage VpreR for display and a reference voltage VpreS for sensing having different voltage levels. The reference voltage VpreR for display may be set to a voltage higher than the reference voltage VpreS for sensing. For example, the reference voltage VpreR for display may be 2 [V], and the reference voltage VpreS for sensing may be a ground voltage GND or 0 [V], but embodiments of the invention are not limited thereto.

The reference voltage VpreR for display may be applied to the reference voltage line 104 during at least a partial interval of the display interval. The reference voltage VpreR for display is applied to the second node n2 via the second switch transistor M2 during the display interval and sets a voltage of a second node n2, that is, a source voltage of the driving transistor DR to an appropriate voltage. The reference voltage VpreS for sensing is not used during the display interval. The reference voltage VpreS for sensing may be applied to the reference voltage line 104 during at least a partial interval of the sensing interval. The reference voltage VpreS for sensing is applied to the second node n2 via the second switch transistor M2 at the beginning of the sensing interval and discharges and initializes the second node n2. The reference voltage VpreR for display is not used in the sensing interval.

The light-emitting element EL may be an OLED, but embodiments of the invention are not limited thereto. The light-emitting element may include an anode electrode, a cathode electrode, and a light-emitting layer disposed between the electrodes.

The driving transistor DR generates a current according to a gate-source voltage Vgs and drives the light-emitting element EL. The gate-source voltage Vgs of the driving transistor DR is equal to a voltage between a first node n1 and the second node n2. The driving transistor DR may include a gate electrode connected to the first node n1, a first electrode connected to the first constant voltage node 106, and a second electrode connected to the second node n2. The pixel driving voltage EVDD is applied to the first constant voltage node 106. The capacitor Cst is connected between the first node n1 and the second node n2, and is charged with the gate-source voltage of the driving transistor DR. In the embodiment, the gate-source voltage Vgs of the driving transistor DR is varied according to the refresh rate. The gate-source voltage Vgs may be varied according to the refresh rate in such a manner that the source voltage of the driving transistor DR, that is, the voltage of the second node n2 is changed while a gate voltage of the driving transistor DR is not changed.

The first switch transistor M1 is connected between the data line 102 and the first node n1, and is turned on in response to a gate on voltage of a first gate signal SCAN. When the first switch transistor M1 is turned on, the data line 102 is electrically connected to the first node n1. The first switch transistor M1 includes a gate electrode connected to a first gate line 1031 to which the first gate signal SCAN is applied, a first electrode connected to the data line 102, and a second electrode connected to the first node n1.

The second switch transistor M2 is connected between the second node n2 and the reference voltage line 104, and is turned on in response to a gate on voltage of a second gate signal SENSE. When the second switch transistor M2 is turned on, the reference voltage line 104 is electrically connected to the second node n2. The second switch transistor M2 includes a gate electrode connected to a second gate line 1032 to which the second gate signal SENSE is applied, a first electrode connected to the second node n2, and a second electrode connected to the reference voltage line 104.

The first and second switch transistors M1 and M2 may be turned on and off simultaneously by the same gate signal. In this case, the first and second switch transistors M1 and M2 may be connected to a single gate line.

The data driver 110 may include a plurality of data channels 112 and a plurality of sensing channels. The data channels 112 input the pixel data of the input image received from the timing controller 130 to the DAC of the data channels 112 and output the data voltage Vdata of the pixel data during the display interval. The data channels 112 output the data voltage Vdata corresponding to the pixel data of the input image during the display interval, and output a preset data voltage for sensing during the sensing interval, regardless of the input image.

The sensing channels of the data driver 110 include the sensing circuit. The sensing circuit is electrically connected to the pixel circuit via the reference voltage line 104.

The sensing circuit may include a sampling switch SAMP, a first reference voltage switch RPRE, a second reference voltage switch SPRE, and an ADC 300. The switches SAMP, RPRE, and SPRE may be implemented as transistors that are turned on under the control of a logic circuit in the data driver 110 or under the control of the timing controller 130.

When the sampling switch SAMP is turned on, the reference voltage line 104 is electrically connected to the ADC 300. The first reference voltage switch RPRE is turned on during the display interval and supplies the reference voltage VpreR for display to the reference voltage line 104. The second reference voltage switch SPRE is turned on during the sensing interval and supplies the reference voltage VpreS for sensing to the reference voltage line 104.

The sensing interval may include an initialization interval t1, a programming interval t2, a sensing interval t3, and a sampling interval t4, as illustrated in FIG. 5. In FIG. 5, "SAM" is a switch control signal that controls an on/off timing of the sampling switch SAMP.

The first switch transistor M1 is turned on in response to a gate high voltage VGH of the first gate signal SCAN during the initialization interval t1. During the initialization interval t1, the data voltage Vdata for sensing is applied to the first node n1 via the first switch transistor M1. During the initialization interval t1, after the first gate signal SCAN increases to the gate high voltage VGH, a control signal of the second reference voltage switch SPRE increases to a high voltage H, and the second reference voltage switch SPRE is turned on. The high voltage H is a voltage at which the switches RPRE, SPRE, and SAMP are turned on. Accordingly, during the initialization interval t1, the second node n2 is charged with the data voltage Vdata for sensing, and the reference voltage line 104 is initialized.

During the programming interval t2, the first switch transistor M1 and the second reference voltage switch SPRE are maintained in an on state. The second switch transistor M2 is turned on in response to a gate high voltage VGH of the second gate signal SENSE during the programming interval t2. The reference voltage VpreS for sensing is applied to the second node n2 via the second switch transistor M2 during the programming interval t2. Accordingly, during the programming interval t2, the gate-source voltage Vgs of the driving transistor DR is set to (Vdata – VpreS). The light-emitting element EL does not emit light during the programming interval t2.

During the sensing interval t3, the first and second switch transistors M1 and M2 are maintained in the on state. During the sensing interval t3, the control signal of the second reference voltage switch SPRE is changed to a low voltage L, and the second reference voltage switch SPRE is turned off. The low voltage L is a voltage at which the switches RPRE, SPRE, and SAMP are turned off. During the sensing interval t3, a sensing voltage Vsen that is charged in a capacitor Cs of the reference voltage line 104 increases to a threshold voltage of the driving transistor DR.

During the sampling interval t4, the second switch transistor M2 is turned off in response to a gate low voltage VGL of the second gate signal SENSE. During the sampling interval t4, the voltage of the switch control signal SAM is generated as a pulse of a high voltage H, and the sampling switch SAMP is turned on. During the sampling interval t4, the sensing voltage Vsen charged in the reference voltage line 104 is supplied to an input terminal of the ADC 300. In this case, the ADC 300 converts the sensing voltage Vsen into a digital signal and outputs the sensing data Dsen. The sensing data Dsen is transmitted to the timing controller 130. During the sensing interval t3 and the sampling interval t4, because a current flowing through the second switch transistor M2 flows into the reference voltage line 104, an anode voltage of the light-emitting element EL does not increase, and the light-emitting element EL is maintained in a turn-off state.

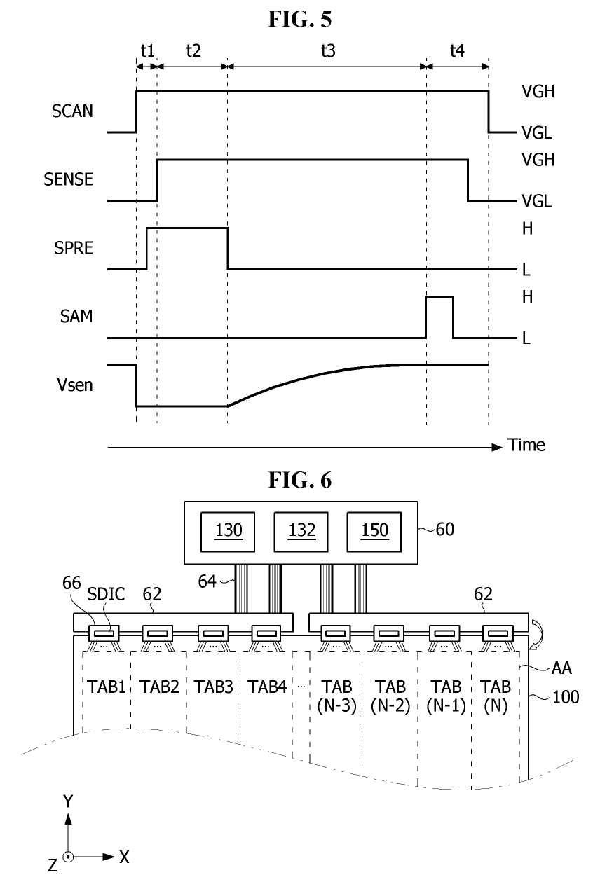

FIG. 6 is a diagram illustrating a connection structure of a display panel and a circuit board according to the embodiment of the invention.

Referring to FIG. 6, a source printed circuit board (PCB) 62 may be electrically connected to the display panel 100. A control PCB 60 may be electrically connected to the source PCB 62 via a flexible soft cable, for example, a flexible flat cable (FFC) 64. The timing controller 130, the power supply 150, the memory 132, and the like may be mounted on the control PCB 60.

A plurality of drive ICs SDIC may be mounted on flexible films of chip on films (COFs) 66 and connected between the source PCB 62 and the display panel 100 in a COF bonding process. The drive ICs SDIC take charge of partial pixel areas TAB1 to TAB(N) of the display area AA, respectively. For example, a first drive IC mounted on a first COF 66 may include data channels that supply data voltages to pixels in a first pixel area TAB1 of the display area AA, and sensing channels that convert voltages sensed from the pixels in the first pixel area TAB1 into digital signals. An N-th drive IC mounted on an N-th (where N is a natural number equal to or greater than two) COF 66 may include data channels that supply data voltages to pixels in an N-th pixel area TAB(N) of the display area AA, and sensing channels that convert voltages sensed from the pixels in the N-th pixel area TAB(N) into digital signals.

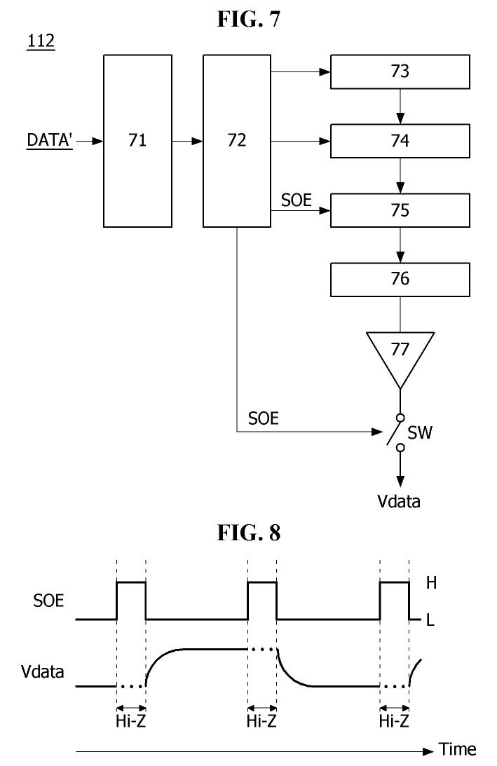

FIG. 7 is a block diagram illustrating a data channel configuration of a drive IC according to the embodiment of the invention. FIG. 8 is a waveform chart illustrating an example of an output signal and a data voltage illustrated in FIG. 7. In FIG. 8, "Hi-Z" represents a high impedance state in which the data line is floated.

Referring to FIGS. 7 and 8, a data channel 112 of the drive IC SDIC may include a receiver 71, a logic controller 72, a shift register 73, a first latch array 74, a second latch array 75, a DAC 76, and an output buffer 77.

The timing controller 130 may convert the clock and data DATA' into a low-voltage differential signal and transmit the converted low-voltage differential signal to the drive IC SDIC via a high-speed serial interface. The data DATA' may be made in units of data packet and transmitted to the drive IC SDIC. The data packet may include a control data packet and a video data packet including the pixel data of the input image (or video data). The control data packet may include at least the data timing control signal to control an operation timing of the drive IC SDIC. A data packet control signal may include a source output enable signal SOE that controls a timing at which the data voltage Vdata is output from the data channel of the drive IC SDIC. The source output enable signal SOE may include a pulse that is generated in a cycle of one horizontal interval. A voltage of the pulse may be the high voltage H as illustrated in FIG. 8. The control data packet may further include the gate timing control signal to control the operation timing of the gate driver 120.

The receiver 71 receives the clock and data DATA' transmitted in series from the timing controller 130. The receiver 71 generates an internal clock to sample each bit of the data DATA' from the received clock, samples the control data and the pixel data of the input image from the data DATA' using the internal clock, and provides the control data and the pixel data of the input image to the logic controller 72.

The logic controller 72 may transfer the pixel data of the input image supplied from the receiver 71 to the shift register 73 and control output timings of the first and second latch arrays 74 and 75 using the restored clock and the control data. The shift register 73, the first latch array 74, and the second latch array 75 convert serial-structure data into parallel-structure data. The shift register 73 sequentially outputs the pixel data input from the logic controller 72 to latches of the first latch array 74. The first latch array 74 sequentially samples the pixel data of the input image input through the shift register 73 in response to the clock from the logic controller 72, and when the pixel data is latched in all latches, outputs the latched pixel data to latches of the second latch array 75 simultaneously. The second latch array 75 latches the pixel data input from the latches of the first latch array 74 simultaneously, and outputs the latched pixel data to the DAC 76 simultaneously under the control of the logic controller 72. The second latch array 75 may output the pixel data latched during an interval of the low voltage L of the source output enable signal SOE as illustrated in FIG. 8 to the DAC 76.

The DAC 76 converts the pixel data input as the digital signal from the second latch array 75 into a gamma compensation voltage and outputs a data voltage Vdata having a voltage level corresponding to a grayscale value of the pixel data. The data voltage Vdata output from the DAC 76 is output through the output buffer 77.

A level shifter (not illustrated) may be disposed between the second latch array 75 and the DAC 76. The level shifter may shift a voltage level of output data of the second latch array 75 to a voltage at which the DAC 76 can operate.

An output switch element SW may be connected to an output terminal of the output buffer 77. The output switch element SW may be implemented as a multiplexer disposed at an output terminal of the drive IC.

The logic controller 72 may apply the source output enable signal SOE to the second latch array 75 and an output switch element SW simultaneously. The second latch array 75 may sample and latch the pixel data from the first latch array 74 in response to the low voltage L of the source output enable signal SOE, and may output the latched pixel data to the DAC 76 in response to the high voltage H of the source output enable signal SOE. The output switch element SW may be turned on in response to the low voltage L of the source output enable signal SOE and transfer a voltage output from the output buffer 77 to a corresponding data line, and may be turned off in response to the high voltage H of the source output enable signal SOE and block an electrical path between the output terminal of the output buffer 77 and the data line.

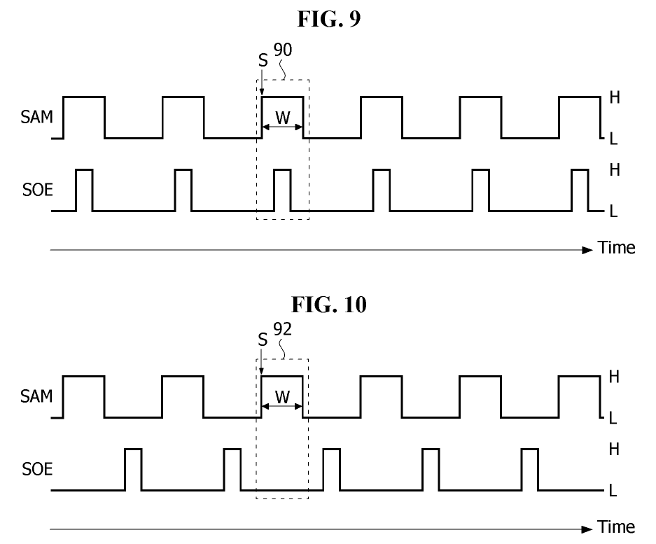

The logic controller 72 may restore the control data received from the timing controller 130 and generate the source output enable signal SOE, and the switch control signal SAM that controls the sampling switch SAMP of the sensing channel. In a non-volatile memory to which the timing controller 130 accesses, a plurality of pieces of timing setting data regarding a pulse start timing (in FIGS. 9 and 10, S) and a pulse width (in FIGS. 9 and 10, W) of each of the source output enable signal SOE and the switch control signal may be stored in the form of a look-up table. The pulse start timing S is a rising time of each of the source output enable signal SOE and the switch control signal, for example, a time at which the voltage of each of the source output enable signal SOE and the switch control signal SAM increases from the low voltage L to the high voltage H in FIGS. 8 to 10. The pulse width W is a pulse duration of each of the source output enable signal SOE and the switch control signal SAM.

The timing controller 130 may individually control the pulse start timing S and the pulse width W by drive IC, input a drive IC-specific sensing data estimation result to the look-up table in which the timing setting data is set, and adjust the pulse duration of the source output enable signal SOE or the switch control signal SAM using data regarding the pulse start timing S and the pulse width W output from the look-up table.

The source output enable signal SOE may turn off the output switch element SW and bring the data line 102 into a floating state in a high impedance mode. The output switch element SW is turned off during an interval (or a pulse width interval) of the high voltage H of the source output enable signal SOE illustrated in FIG. 8 and electrically separate the output terminal of the output buffer 77 from the data line 102. In this case, the data line 102 is floated. During the interval of the low voltage L of the source output enable signal SOE, the output switch element SW is turned on and electrically connects the output terminal of the output buffer 77 to the data line 102, and the data voltage Vdata from the DAC 76 is supplied to the data line 102 through the output buffer 77 and the output switch element SW.

When the electrical characteristics of the sub-pixel are sensed in a state in which the data line is floated, the data line may be affected by coupling with other signal lines and power lines of the display panel, and a data voltage for sensing that is applied to the data line may fluctuate. In this case, the sensing data Dsen indicating the electrical characteristics of the sub-pixel is incorrect. This may result in incorrect compensation for the deterioration of the electrical characteristics of the driving transistor and/or the light-emitting element in the sub-pixel. As a result, a stain may be viewed on the screen of the display panel, or a dim block may be visible due to a luminance difference between the partial pixel areas TAB1 to TAB(N) of which the drive ICs are in charge.

FIG. 9 is a waveform chart illustrating an example where the pulse of the source output enable signal and the pulse of the switch control signal temporally overlap each other. FIG. 10 is a waveform chart illustrating an example where the pulse of the source output enable signal and the pulse of the switch control signal do not temporally overlap each other.

Referring to FIGS. 5, 9, and 10, the pulse of the source output enable signal SOE may be generated as the high voltage H. The drive IC SDIC is electrically separated from the data line 102 in response to the pulse of the source output enable signal SOE. The data voltage for sensing that is applied to the data line 102 during the sensing interval may be floated at the pulse timing of the source output enable signal SOE and may fluctuate due to coupling with adjacent signal/power lines.

The switch control signal SAM includes a pulse indicating a sampling timing of the sensing voltage during the sensing interval. The pulse of the switch control signal SAM may be generated as the high voltage H. The sampling switch SAMP is turned on in response to the pulse of the switch control signal SAM and supplies the sensing voltage charged in the reference voltage line 104 to the ADC 300.

The pulse of each of the source output enable signal SOE and the switch control signal SAM may be generated as the low voltage L according to the channel type of the transistor.

The pulse of the source output enable signal SOE and the pulse of the switch control signal SAM may overlap each other (90) on a time axis. In this case, the data voltage for sensing may fluctuate, and the gate-source voltage Vgs of the driving transistor DR may be changed, and the sensing data that is input to the timing controller 130 may be changed. In this case, because the sensing data is incorrect, the deterioration of the electrical characteristics of the sub-pixel may be excessively or insufficiently compensated for.

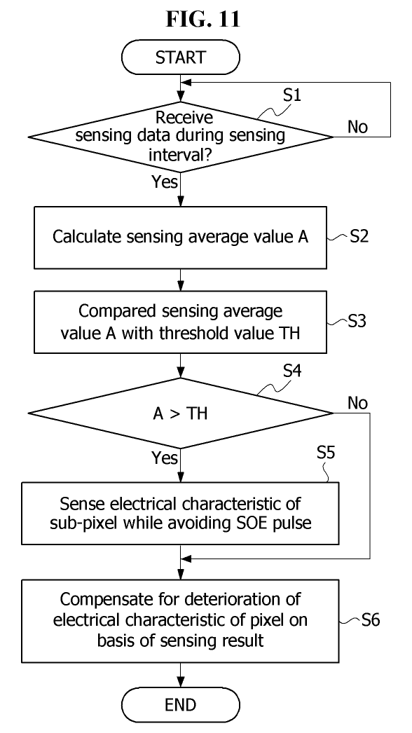

To reduce the fluctuation of the sensing data, the timing controller 130 may change (for example, delay) the pulse start timing S and/or change the pulse width W of the source output enable signal SOE or the switch control signal SAM on the basis of a result of estimating the drive IC-specific sensing data, thereby preventing the fluctuation of the sensing data. The timing controller 130 may determine a drive IC that outputs abnormal sensing data with a large error, compared to other drive ICs on the basis of the result of estimating the drive IC-specific sensing data. The timing controller 130 may delay the pulse of the source output enable signal SOE or the switch control signal SAM of the drive IC that outputs abnormal sensing data, thereby performing control such that the pulses of the signals SOE and SAM do not overlap each other as a portion 92 indicated by a dotted line in FIG. 10. With a control procedure as illustrated in FIG. 11, the timing controller 130 may control the pulse start timing S and the pulse width W of the source output enable signal SOE or the switch control signal SAM such that the sensing voltage is sampled while avoiding the floating interval of the data line, that is, the pulse of the source output enable signal SOE.

FIG. 11 is a flowchart illustrating a driving method of the display device according to the embodiment of the invention.

Referring to FIG. 11, the timing controller 130 may receive the sensing data from the drive IC SDIC during the sampling interval of the sensing interval (S1). The timing controller 130 calculates an average value A of the sensing data received from the drive IC SDIC (S2). The timing controller 130 compares the average value A of the sensing data with a preset first threshold value TH1 (S3). The first threshold value TH1 may be a normal change value of the change values of the electrical characteristics of the sub-pixels, and may be determined experimentally.

When the average value A is greater than the first threshold value TH1, the timing controller 130 may change (for example, delay) the pulse start timing and/or change the pulse width of the source output enable signal SOE or the switch control signal SAM such that the electrical characteristic of the sub-pixel is sensed while avoiding the pulse of the source output enable signal SOE (S4 and S5). The timing controller 130 receives the sensing data for the electrical characteristic of the sub-pixel sensed while avoiding the pulse of the source output enable signal SOE, selects a compensation value corresponding to the sensing data, and compensates for the deterioration of the electrical characteristic of the sub-pixel (S6).

A plurality of drive ICs SDIC may be connected to the display panel 100. In this case, in Step S2, the timing controller 130 receives the sensing data from the plurality of drive ICs SDIC during the sampling interval of the sensing interval and calculates an average value A of the sensing data by drive IC. In Step S3, the timing controller 130 compares a difference between the average values A obtained from adjacent drive ICs SDIC with the second threshold value TH2.

In Step S4, when the difference between the average values A obtained from adjacent drive ICs SDIC is greater than the second threshold value TH2, the timing controller 130 may determine a drive IC SDIC that outputs abnormal sensing data. When the drive IC that outputs abnormal sensing data is determined, in Step S5, the timing controller 130 changes (for example, delays) the pulse start timing and/or changes the pulse width of the source output enable signal SOE or the switch control signal SAM of the drive IC and makes the drive IC sense the electrical characteristic of the sub-pixel while avoiding the pulse of the source output enable signal SOE.

For example, a difference between a first average value of sensing data obtained from a first drive IC and a second average value of sensing data obtained from a second drive IC may be compared with the second threshold value TH2. Further, a difference between the second average value obtained from the second drive IC and a third average value of sensing data obtained from a third drive IC may be compared with the second threshold value TH2. When the difference between the first average value and the second average value is greater than the second threshold value TH2, and the difference between the second average value and the third average value is greater than the second threshold value TH2, the second drive IC may be determined as a drive IC that outputs abnormal sensing data. In this case, the timing controller 130 transmits, to the second drive IC, control data indicating the pulse start timing and the pulse width of each of the source output enable signal SOE and the switch control signal SAM of the second drive IC. In this case, the pulse timing of the source output enable signal SOE restored from the second drive IC may be adjusted not to overlap the pulse of the switch control signal SAM during the sampling interval of the sensing interval.

According to one or more embodiments of the invention, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the invention may be applied to organic light emitting lighting devices or inorganic light emitting lighting devices.

According to the embodiments of the invention, it is possible to obtain accurate sensing data while avoiding a floating interval of a data line by estimating the sensing result of the electrical characteristics of the sub-pixels by drive IC and delaying the start timing and the pulse width of the pulse of the source output enable signal or the sampling switch control signal that controls the drive IC outputting abnormal sensing data with a large error.

According to the embodiments of the invention, it is possible to extend the lifetime of the display panel by appropriately compensating for the deterioration of the sub-pixels on the basis of the sensing result of the electrical characteristics of the sub-pixels of the display device.

According to the embodiments of the invention, it is possible to improve the image quality of the image reproduced on the screen of the display panel without a stain or block dim by appropriately delaying the pulse of the source output enable signal or the sampling switch control signal of the drive IC that outputs abnormal sensing data, among a plurality of drive ICs.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a display panel including a plurality of data lines, a plurality of gate lines, a plurality of reference voltage lines, and a plurality of sub-pixels;
a data driver including a data channel connected to the data lines and the reference voltage lines and configured to output a data voltage in response to a source output enable signal, and a sensing channel configured to sample voltages of the reference voltage lines in response to a switch control signal and output sensing data during a sensing interval;
a gate driver connected to the gate lines; and
a timing controller configured to transmit control data indicating a pulse timing and pixel data of an input image to the data driver,
wherein:
the data channel of the data driver includes an output switch element that blocks an electrical path between the data channel and the data line in response to a pulse of the source output enable signal; and
the pulse of the source output enable signal and a pulse of the switch control signal do not temporally overlap each other during the sensing interval.

2. The display device according to claim 1, further comprising a memory configured to store a plurality of pieces of timing setting data with different pulse start timings and pulse widths,
wherein:
the control data includes pulse start timing and pulse width information; and
the timing controller is configured to adjust a pulse timing of one of the source output enable signal and the switch control signal on the basis of the pulse start timing and the pulse width read from the memory.

3. The display device according to claim 1, wherein:
the timing controller is configured to transmit control data packet including data indicating a pulse start timing and a pulse width to the data driver; and
the data driver is configured to generate the pulse of the source output enable signal or the pulse of the switch control signal on the basis of the pulse start timing and the pulse width restored from the control data packet.

4. The display device according to claim 1, wherein:
each of the sub-pixels is connected to corresponding data line, gate line, and reference voltage line;
the sensing channel of the data driver includes:
an analog-to-digital converter configured to convert a voltage charged in the reference voltage line into a digital signal and output the sensing data; and
a sampling switch configured to connect the reference voltage line to an input terminal of the analog-to-digital converter in response to the pulse of the switch control signal during a sampling interval of the sensing interval; and
the sensing data is transmitted to the timing controller.

5. The display device according to claim 4, wherein:
the data channel of the data driver further includes:
a digital-to-analog converter configured to convert the pixel data into a data voltage; and
an output buffer configured to output the data voltage output from the digital-to-analog converter; and
the output switch element is connected to an output terminal of the output buffer and is configured to electrically separate the output terminal of the output buffer from the corresponding data line in response to the pulse of the source output enable signal and electrically connect the output terminal of the output buffer to the corresponding data line during an interval of a low voltage of the source output enable signal.

6. The display device according to claim 4, wherein the timing controller is configured to:
calculate an average value of sensing data received from the data driver during the sensing interval;
compare the average value of the sensing data with a preset first threshold value; and
when the average value is greater than the first threshold value, change a pulse start timing and/or a pulse width of the source output enable signal or the switch control signal to control the pulse of the source output enable signal and the pulse of the switch control signal in a non-overlapping state.

7. The display device according to claim 4, further comprising a plurality of drive ICs including the data driver,
wherein:
a data channel of each of the drive ICs is electrically connected to the corresponding data line during an interval of a low voltage of the source output enable signal and is electrically separated from the corresponding data line in response to the pulse of the source output enable signal; and
a sensing channel of each of the drive ICs is electrically connected to the reference voltage line using a switch that responds to the pulse of the switch control signal and is electrically separated from the reference voltage line during an interval of a low voltage of the switch control signal.

8. The display device according to claim 7, wherein the timing controller is configured to:
calculate an average value of sensing data received from each of the drive ICs during the sensing interval by drive IC;
compare a difference between the average values calculated for adjacent drive ICs with a preset second threshold value;
when the difference between the average values obtained from the adjacent drive ICs is greater than the second threshold value, determine one of the adjacent drive ICs as a drive IC that outputs abnormal sensing data; and
delay the pulse of the source output enable signal or the pulse of the switch control signal that controls the drive IC outputting the abnormal sensing data, to control the pulse of the source output enable signal and the pulse of the switch control signal that control the drive IC outputting the abnormal sensing data in a non-overlapping state.

9. A method for driving a display device, the display device including a display panel in which a plurality of data lines, a plurality of gate lines, a plurality of reference voltage lines, and a plurality of sub-pixels are disposed; and a data driver including a data channel connected to the data lines and the reference voltage lines and configured to output a data voltage in response to a source output enable signal, and a sensing channel configured to sample voltages of the reference voltage lines in response to a switch control signal and output sensing data during a sensing interval, the method comprising:
transmitting control data indicating a pulse timing to the data driver;
by the data driver, generating a pulse of the source output enable signal and a pulse of the switch control signal on the basis of the control data; and
causing the pulse of the source output enable signal and the pulse of the switch control signal not to overlap each other during the sensing interval,
wherein the data channel of the data driver includes an output switch element that blocks an electrical path between the data channel and the data line in response to a pulse of the source output enable signal.

10. The method for driving a display device according to claim 9, further comprising:
by a timing controller, transmitting a control data packet including data indicating a pulse start timing and a pulse width to the data driver; and
by the data driver, generating the pulse of the source output enable signal or the pulse of the switch control signal on the basis of the pulse start timing and the pulse width restored from the control data packet.

11. The method for driving a display device according to claim 10, further comprising:
by the timing controller, calculating an average value of sensing data received from the data driver during the sensing interval;
by the timing controller, comparing the average value of the sensing data with a preset first threshold value; and
by the timing controller, when the average value is greater than the first threshold value, changing a pulse start timing and/or a pulse width of the source output enable signal or the switch control signal to control the pulse of the source output enable signal and the pulse of the switch control signal in a non-overlapping state.

12. The method for driving a display device according to claim 10, further comprising:
causing a data channel of each of a plurality of drive ICs with the data driver integrated to be electrically connected to a corresponding data line during an interval of a low voltage of the source output enable signal and electrically separated from the corresponding data line in response to the pulse of the source output enable signal; and
causing a sensing channel of each of the drive ICs to be electrically connected to the reference voltage line using a switch that responds to the pulse of the switch control signal and electrically separated from the reference voltage line during an interval of a low voltage of the switch control signal.

13. The method for driving a display device according to claim 12, further comprising:
by the timing controller, calculating an average value of sensing data received from each of the drive ICs during the sensing interval by drive IC;
by the timing controller, comparing a difference between the average values calculated for adjacent drive ICs with a preset second threshold value;
by the timing controller, when the difference between the average values obtained from the adjacent drive ICs is greater than the second threshold value, determining one of the adjacent drive ICs as a drive IC that outputs abnormal sensing data; and
by the timing controller, delaying the pulse of the source output enable signal or the pulse of the switch control signal that controls the drive IC outputting the abnormal sensing data, to control the pulse of the source output enable signal and the pulse of the switch control signal that control the drive IC outputting the abnormal sensing data in a non-overlapping state.
